(19) United States
(12) Patent Application Publication
(10) Pub. No.: US 2006/0262056 A1
(43) Pub. Date: Nov. 23, 2006

(54) DISPLAY DEVICE

(75) Inventors: Yuichi MASUTANI, Tokyo (JP); Naoki Nakagawa, Tokyo (JP); Shinji Kawabuchi, Tokyo (JP); Shigeru Yachi, Tokyo (JP); Kazunori Okumoto, Kumamoto (JP); Yukio Ijima, Kumamoto (JP); Takayuki Fukuda, Kumamoto (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Chiyoda-ku (JP)

(21) Appl. No.: 11/279,482

(22) Filed: Apr. 12, 2006

(30) Foreign Application Priority Data
May 19, 2005 (JP) 2005-146546

(51) Int. Cl. G09G 3/36

(52) U.S. Cl. 345/87

(57) ABSTRACT

The present invention provides a display device capable of reducing cost by reduction in number of integrators. Signal lines (9₁ to 9₄, 9₅ to 9₈, 9₉ to 9₁₂, 9₁₃ to 9₁₆) are brought together into one line by means of signal lines (10a, 10b, 10c, 10d) to be connected to integrators (4a, 4b, 4c, 4d), respectively. Selector lines (7₁ to 7₄) orthogonal to the signal lines (9₁ to 9₁₆) are formed and connected to a selector driving circuit (3). An a-SiTFT (12) is formed at each of intersections: an intersection of the selector line (7₁) and the signal lines (9₁, 9₅, 9₉, 9₁₃); an intersection of the selector line (7₂) and the signal lines (9₂, 9₆, 9₁₀, 9₁₄); an intersection of the selector line (7₃) and the signal lines (9₃, 9₇, 9₁₁, 9₁₅); and an intersection of the selector line (7₄) and the signal lines (9₄, 9₈, 9₁₂, 9₁₆). The selector lines (7₁ to 7₄) are driven in sequence by the selector driving circuit (3) in the frame period.

### BACKGROUND OF THE INVENTION

1. Field of the Invention

The present invention relates to a display device, and particularly to a liquid crystal display device with a built-in sensor array having a touch panel function.

2. Description of the Background Art

A conventional liquid crystal display device with a built-in sensor array includes a plurality of source lines formed by being extended in a row direction within a display screen, a plurality of gate lines formed by being extended in a column direction within the display screen, pixel sensors each arranged at an intersection of each of the source lines and gate lines, a plurality of signal lines formed by being extended in the row direction, and integrators connected to the signal lines. Each of the signal lines is connected to a plurality of pixel sensors belonging to the same row as each of the signal lines. By sequential driving of the plurality of gate lines, a signal sent from a pixel sensor on each row corresponding to the gate line being driven, through the signal line on each row, is read with the integrator on each row.

It is to be noted that a technique on a liquid crystal display device, in which a light sensor is formed on each of a plurality of pixels arranged in matrix form and which has the function of detecting a position coordinate within a display screen pointed with a light pen is for example disclosed in Japanese Patent Application Laid-Open No. 04-222018 (1992).

As thus described, in the conventional liquid crystal display device with a built-in sensor array, the integrators are each arranged corresponding to each of the plurality of signal lines. Hence, there is a problem in that, when the number of signal lines increases due to upsizing or resolution improvement of the display screen, the number of integrators also increases in proportion to the signal line increase, which may incur cost rise.

### SUMMARY OF THE INVENTION

An object of the present invention is to obtain a display device capable of reducing cost by reduction in number of integrators.

According to a first aspect of the present invention, a display device includes first and second source lines, a gate line, first and second pixel sensors, first and second signal lines, an integrator, and a selector. The first and second source lines are formed within a display screen. The gate line is formed within the display screen and is orthogonal to the first and second source lines. The first pixel sensor is arranged corresponding to an intersection of the first source line and the gate line. The second pixel sensor is arranged corresponding to an intersection of the second source line and the gate line. The first signal line is connected to the first pixel sensor. The second signal line is connected to the second pixel sensor. The selector selectively connects the first and second signal lines to the integrator.

It is possible to reduce the number of integrators.

According to a second aspect of the present invention, a display device includes first to fourth source lines, a gate line, first to fourth pixel sensors, first to fourth signal lines, an integrator, and first to third selectors. The first to fourth source lines are formed within a display screen. The gate line is formed within the display screen and is orthogonal to the first to fourth source lines. The first pixel sensor is arranged corresponding to an intersection of the first source line and the gate line. The second pixel sensor is arranged corresponding to an intersection of the second source line and the gate line. The third pixel sensor is arranged corresponding to an intersection of the third source line and the gate line. The fourth pixel sensor is arranged corresponding to an intersection of the fourth source line and the gate line. The first signal line is connected to the first pixel sensor. The second signal line is connected to the second pixel sensor. The third signal line is connected to the third pixel sensor. The fourth signal line is connected to the fourth pixel sensor. The first selector is connected to the integrator. The second selector selectively connects the first and second signal lines to the first selector. The third selector selectively connects the third and fourth signal lines to the first selector. The first selector selectively connects the second and third selectors to the integrator.

It is possible to reduce the number of integrators.

According to a third aspect of the present invention, a display device includes first to fourth source lines, first and second gate lines, first to fourth pixel sensors, first to sixth signal lines, an integrator, and a selector. The first to fourth source lines are formed within a display screen. The first and second gate lines are formed within the display screen, are orthogonal to the first to fourth source lines, and are driven in sequence. The first pixel sensor is arranged corresponding to an intersection of the first source line and the first gate line. The second pixel sensor is arranged corresponding to an intersection of the second source line and the second gate line. The third pixel sensor is arranged corresponding to an intersection of the third source line and the first gate line. The fourth pixel sensor is arranged corresponding to an intersection of the fourth source line and the second gate line. The first signal line is connected to the first pixel sensor. The second signal line is connected to the second pixel sensor. The third signal line is connected to the third pixel sensor. The fourth signal line is connected to the fourth pixel sensor. The fifth signal line is connected to the first and second signal lines. The sixth signal line is connected to the third and fourth signal lines. The selector selectively connects the fifth and sixth signal lines to the integrator.

It is possible to reduce the number of integrators.

According to a fourth aspect of the present invention, a display device includes first to fourth source lines, first and second gate lines, first to fourth pixel sensors, first to fourth signal lines, an integrator, and a selector. The first to fourth source lines are formed within a display screen. The first and second gate line are formed within the display screen, are orthogonal to the first to fourth source lines, and are driven in sequence. The first pixel sensor is arranged corresponding to an intersection of the first source line and the first gate line. The second pixel sensor is arranged corresponding to an intersection of the second source line and the first gate line. The third pixel sensor is arranged corresponding to an intersection of the third source line and the second gate line. The fourth pixel sensor is arranged corresponding to an intersection of the fourth source line and the second gate line. The first signal line is connected to the first pixel sensor. The second signal line is connected to the second pixel sensor. The third signal line is connected to the third pixel sensor. The fourth signal line is connected to the fourth pixel sensor. The selector selectively connects the first and second signal lines to the integrator, and selectively connects the third and fourth signal lines to the integrator.

It is possible to reduce the number of integrators.

According to a fifth aspect of the present invention, a display device includes first and second source lines, first and second gate lines, first and second pixel sensors, first and second signal lines, and an integrator.

The first and second source lines are formed within a display screen. The first and second gate lines are formed within the display screen, are orthogonal to the first and second source lines, and are driven in sequence. The first pixel sensor is arranged corresponding to an intersection of the first source line and the first gate line. The second pixel sensor is arranged corresponding to an intersection of the second source line and the second gate line. The first signal line is connected to the first pixel sensor. The second signal line is connected to the second pixel sensor. The integrator is connected to the first and second signal lines.

It is possible to reduce the number of integrators.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view schematically showing a configuration of a liquid crystal display device with a built-in sensor array according to a first embodiment of the present invention;

FIG. 2 is a timing chart showing the timing for driving selector lines by a selector driving circuit, regarding the liquid crystal display device with a built-in sensor array according to the first embodiment of the present invention;

FIG. 3 is a timing chart showing the timing for driving selector lines by a selector driving circuit, regarding a liquid crystal display device with a built-in sensor array according to a second embodiment of the present invention;

FIG. 4 is a view showing a modification of the configuration shown in FIG. 1;

FIG. 5 is a view schematically showing a configuration of a liquid crystal display device with a built-in sensor array according to a third embodiment of the present invention;

FIG. 6 is a timing chart showing the timing for driving selector lines by a selector driving circuit, regarding the liquid crystal display device with a built-in sensor array according to the third embodiment of the present invention;

FIG. 7 is a view schematically showing a configuration of a liquid crystal display device with a built-in sensor array according to a fourth embodiment of the present invention;

FIG. 8 is a view schematically showing a configuration of a liquid crystal display device with a built-in sensor array according to a fifth embodiment of the present invention;

FIG. 9 is a view schematically showing a configuration of a liquid crystal display device with a built-in sensor array according to a sixth embodiment of the present invention;

FIG. 10 is a view schematically showing a configuration of a liquid crystal display device with a built-in sensor array according to a seventh embodiment of the present invention;

FIG. 11 is a timing chart showing the timing for driving selector lines by a selector driving circuit, regarding the liquid crystal display device with a built-in sensor array according to the seventh embodiment of the present invention; and

FIG. 12 is a view schematically showing a configuration of a liquid crystal display device with a built-in sensor array according to an eighth embodiment of the present invention.

### DESCRIPTION OF THE PREFERRED EMBODIMENTS

### First Embodiment

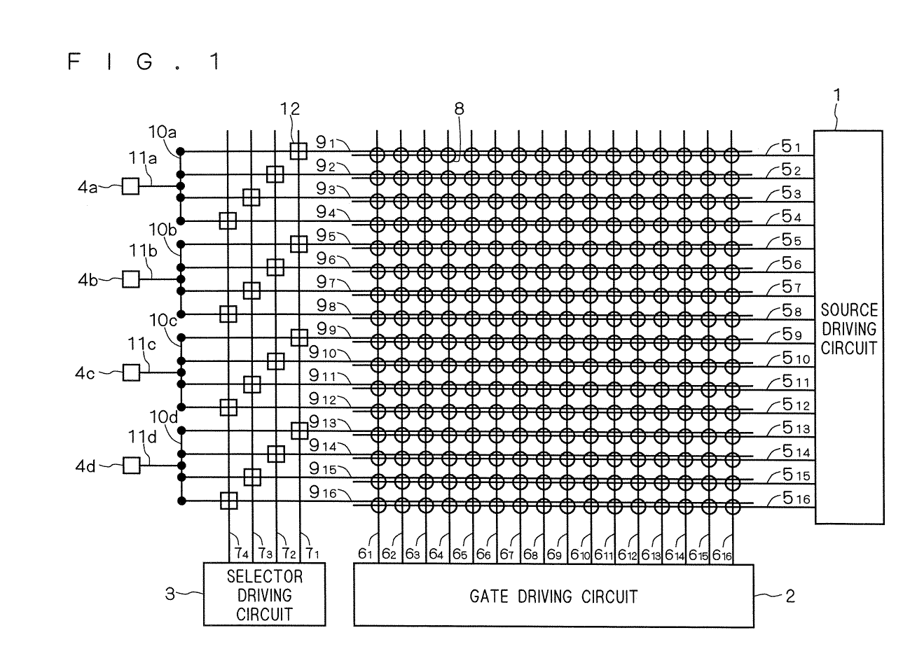

FIG. 1 is a view schematically showing a configuration of a liquid crystal display device with a built-in sensor array having a touch panel function according to a first embodiment of the present invention. Within a display screen, a plurality of source lines 5₁ to 5₁₆ are formed by being extended along a row direction. The source lines 5₁ to 5₁₆ are connected to a source driving circuit 1. Further, within the display screen, a plurality of gate lines 6₁ to 6₁₆ are formed by being extended along a column direction. The gate lines 6₁ to 6₁₆ are connected to a gate driving circuit 2. The gate driving circuit 2 drives the gate lines 6₁ to 6₁₆ in sequence in a predetermined horizontal period (hereinafter, referred to as “gate period”). In the following description, the gate lines are assumed to be driven in the order of 6₁, 6₂, 6₃, . . . . One frame is constituted by driving of the gate lines 6₁ to 6₁₆.

At each of intersections of the source lines 5₁ to 5₁₆ and the gate lines 6₁ to 6₁₆, a pixel having an amorphous silicon thin film transistor (hereinafter, referred to as “a-SiTFT”) is arranged. A gate electrode of the a-SiTFT is connected to each of the gate lines 6₁ to 6₁₆, and a source electrode thereof is connected to each of the source lines 5₁ to 5₁₆. In each of the pixels, an arbitrary type pixel sensor 8, such as a photo-sensor, is formed. It is to be noted that, in FIG. 1, both the number of source lines and the number of gate lines are 16 for the sake of simplification. However, these numbers are not limited thereto, and further larger numbers of source lines and gate lines are formed in reality. The same can be said for second to eighth embodiments to be described later.

A plurality of signal lines 9₁ to 9₁₆ are formed by being extended in the row direction, corresponding to the source lines 5₁ to 5₁₆. Each of the signal lines 9₁ to 9₁₆ is connected to a plurality (16 in the example shown in FIG. 1) of pixel sensors 8 belonging to the same row as each of the signal lines. The signal lines 9₁ to 9₄ are connected to a signal line 10a, and this signal line 10a is connected to an integrator 4a through a signal line 11a. Namely, the four signal lines 9₁ to 9₄ are brought together into one line by means of the signal line 10a, to be connected to one integrator 4a. Respective signals detected with the pixel sensors 8 connected to the signal lines 9₁ to 9₄ are read with the integrator 4a through the signal lines 9₁ to 9₄, 10a and 11a. Similarly, the signal lines 9₅ to 9₈, 9₉ to 9₁₂, 9₁₃ to 9₁₆ are respectively connected to the signal lines 10b, 10c, 10d, and the signal lines 10b, 10c, 10d are connected to integrators 4b, 4c, 4d through the signal lines 11b, 11c, 11d, respectively.

A plurality of selector lines 7₁ to 7₄, orthogonal to the signal lines 9₁ to 9₁₆, are formed and connected to a selector driving circuit 3. The a-SiTFT 12 is formed at each of intersections of the selector line 7₁ and the signal lines 9₁, 9₅, 9₉, 9₁₃, intersections of the selector line 7₂ and the signal lines 9₂, 9₆, 9₁₀, 9₁₄, intersections of the selector line 7₃ and the signal lines 9₃, 9₇, 9₁₁, 9₁₅, and intersections of the selector line 7₄ and the signal lines 9₄, 9₈, 9₁₂, 9₁₆. For example, the a-SiTFT 12 formed at the intersection of the selector line 7₁ and the signal line 9₁ has a gate electrode connected to the selector line 7₁ and a source electrode and a drain electrode which are connected to the signal line 9₁. The a-SiTFT 12 is turned on by driving of the selector line 7₁ by the selector driving circuit 3, to bring the signal line 9₁ into conduction.

Since four a-SiTFTs 12 are connected to the selector line 7₁, the signal lines 9₁, 9₅, 9₉, 9₁₃ are concurrently brought into conduction by driving of the selector line 7₁. This applies to the other selector lines 7₂ to 7₄. The signal lines 9₂, 9₆, 9₁₀, 9₁₄ are concurrently brought into conduction by driving of the selector line 7₂. The signal lines 9₃, 9₇, 9₁₁, 9₁₅ are concurrently brought into conduction by driving of the selector line 7₃. The signal lines 9₄, 9₈, 9₁₂, 9₁₆ are concurrently brought into conduction by driving of the selector line 7₄.

The a-SiTFT 12 arranged at each of intersections of the selector lines 7₁ to 7₄ and the signal lines 9₁ to 9₁₆ outside the display screen can be formed in the same process as the a-SiTFT 12 arranged at each of the intersections of the source lines 5₁ to 5₁₆ and the gate lines 6₁ to 6₁₆ within the display screen. Namely, a change in mask pattern allows formation of the a-SiTFTs 12 outside the display screen concurrently with the formation of the a-SiTFTs within the display screen in the array production process. This can reduce production cost as compared to the case of forming the a-SiTFTs 12 in a separate process from the formation process for the a-SiTFTs within the display screen. This also applies to second to eighth embodiments to be described later.

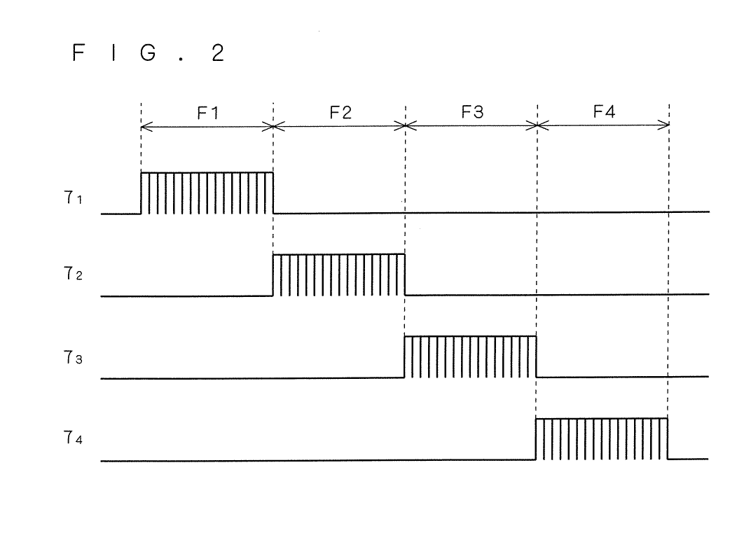

FIG. 2 is a timing chart showing the timing for driving the selector lines 7₁ to 7₄ by the selector driving circuit 3. The selector driving circuit 3 drives the selector lines 7₁ to 7₄ in sequence in a frame period. Specifically, the selector line 7₁ is driven in a first frame F1, the selector line 7₂ is driven in a second frame F2, the selector line 7₃ is driven in a third frame F3, and the selector line 7₄ is driven in a fourth frame F4. Thereby, for example in the first frame F1, signals detected in sequence in a gate period by the pixel sensor 8 connected to the signal lines 9₁, 9₅, 9₉, 9₁₃ are read with the integrators 4a, 4b, 4c, 4d, respectively. Signals respectively detected with all the pixel sensors 8 within the display screen during four frame periods from the first frame F1 to the fourth frame F4 are read with the integrators 4a to 4d.

As thus described, according to the liquid crystal display device with a built-in sensor array of the first embodiment, the signal lines 9₁ to 9₄, 9₅ to 9₈, 9₉ to 9₁₂, 9₁₃ to 9₁₆ are respectively brought together by means of the signal lines 10a, 10b, 10c, 10d, to be connected to the integrators 4a, 4b, 4c, 4d. Hence, arrangement of the total four integrators 4a to 4d is sufficient with respect to the total sixteen signal lines 9₁ to 9₁₆. This can result in reduction in number of integrators, which permits an attempt to reduce cost, as compared to the case of arrangement of the integrator on every signal line.

### Second Embodiment

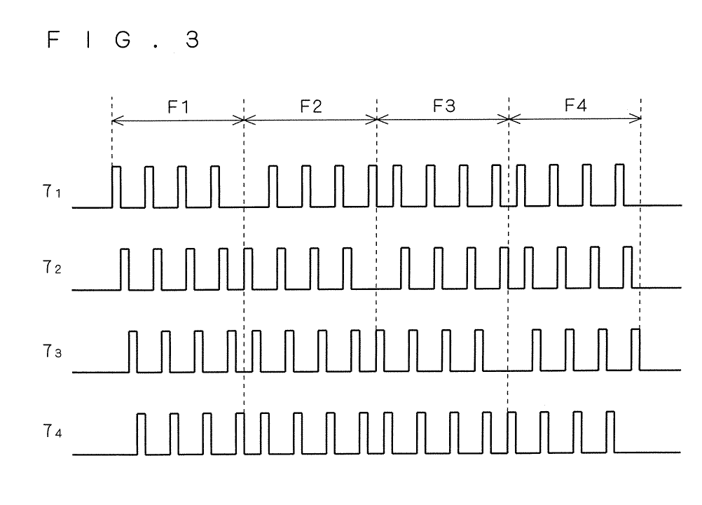

FIG. 3 is a timing chart showing the timing for driving the selector lines 7₁ to 7₄ by the selector driving circuit 3. A liquid crystal display device with a built-in sensor array according to the second embodiment has a similar configuration to the configuration shown in FIG. 1. The selector driving circuit 3 drives the selector lines 7₁ to 7₄ in sequence in the gate period. Specifically, as shown in FIG. 3, the selector lines are driven in the order of 7₁, 7₂, 7₃, 7₄, 7₁, . . . , 7₄ in the first frame F1, the selector lines are driven in the order of 7₂, 7₃, 7₄, 7₁, 7₂, . . . , 7₁ in the second frame F2, the selector lines are driven in the order of 7₃, 7₄, 7₁, 7₂, 7₃, . . . , 7₂ in the third frame F3, and the selector lines are driven in the order of 7₄, 7₁, 7₂, 7₃, 7₄, . . . , 7₃ in the fourth frame F4. In a similar manner to the case of the liquid crystal display device according to the first embodiment, signals respectively detected with all the pixel sensors 8 within the display screen during four frame periods from the first frame F1 to the fourth frame F4 are read with the integrators 4a to 4d.

Similarly to the liquid crystal display device according to the first embodiment, it is also possible to reduce the number of integrators according to the liquid crystal display device with a built-in sensor array of the second embodiment since arrangement of the total four integrators 4a to 4d is sufficient with respect to the total sixteen signal lines 9₁ to 9₁₆, thereby permitting an attempt to reduce cost.

### Third Embodiment

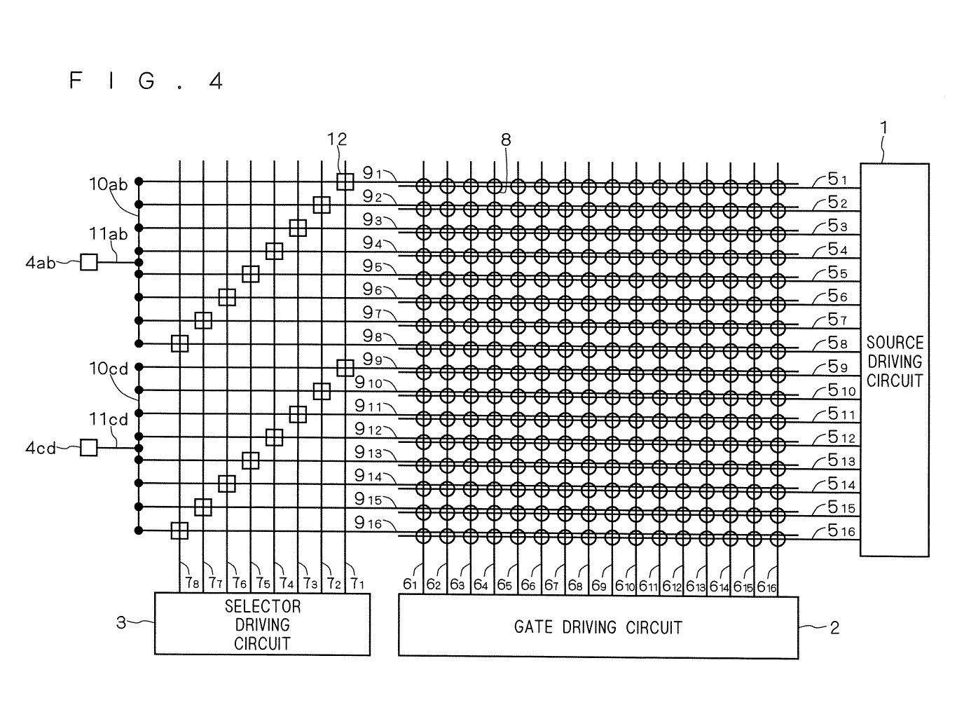

FIG. 4 is a view showing a modification of the liquid crystal display device according to the first embodiment shown in FIG. 1. In the configuration shown in FIG. 1, the four signal lines are brought together into one line to reduce the number of integrators to four. In the configuration shown in FIG. 4, the number of integrator is further reduced by increasing the number of signal lines which are brought together into one line. Signal lines 9₁ to 9₈ are connected to a signal line 10ab, and this signal line 10ab is connected to an integrator 4ab through a signal line 11ab. Namely, the eight signal lines 9₁ to 9₈ are brought together into one line by means of the signal line 10ab, to be connected to one integrator 4ab. Similarly, signal lines 9₉ to 9₁₆ are connected to a signal line 10cd, and this signal line 10cd is connected to an integrator 4cd through a signal line 11cd.

Eight selector lines 7₁ to 7₈, orthogonal to the signal lines 9₁ to 9₁₆, are formed and connected to the selector driving circuit 3. The a-SiTFT 12 is formed at each of intersections of the selector line 7₁ and the signal lines 9₁, 9₉, intersections of the selector line 7₂ and the signal lines 9₂, 9₁₀, intersections of the selector line 7₃ and the signal lines 9₃, 9₁₁, intersections of the selector line 7₄ and the signal lines 9₄, 9₁₂, intersections of the selector line 7₅ and the signal lines 9₅, 9₁₃, intersections of the selector line 7₆ and the signal lines 9₆, 9₁₄, intersections of the selector line 7₇ and the signal lines 9₇, 9₁₅, and intersections of the selector line 7₈ and the signal lines 9₈, 9₁₆.

As in the case of the liquid crystal display device according to the first embodiment, the selector driving circuit 3 drives the selector lines 7₁ to 7₈ in sequence in the frame period. Alternatively, as in the case of the liquid crystal display device according to the second embodiment, the selector driving circuit 3 drives the selector lines 7₁ to 7₈ in sequence in the gate period. In either case, signals respectively detected with all the pixel sensors 8 within the display screen during eight frame periods from the first frame F1 to the eighth frames F8 are read with the integrators 4ab, 4cd.

According to the configuration shown in FIG. 4, arrangement of the total two integrators 4ab, 4cd is sufficient with respect to the total sixteen signal lines 9₁ to 9₁₆. However, with increase in number of the selector lines 7₁ to 7₈, an area of a region to be secured for formation of the selector lines 7₁ to 7₈ increases, leading to upsizing of the device as a whole. Therefore, in the third embodiment, a configuration is described which is capable of reducing the number of selector lines from the configuration shown in FIG. 4.

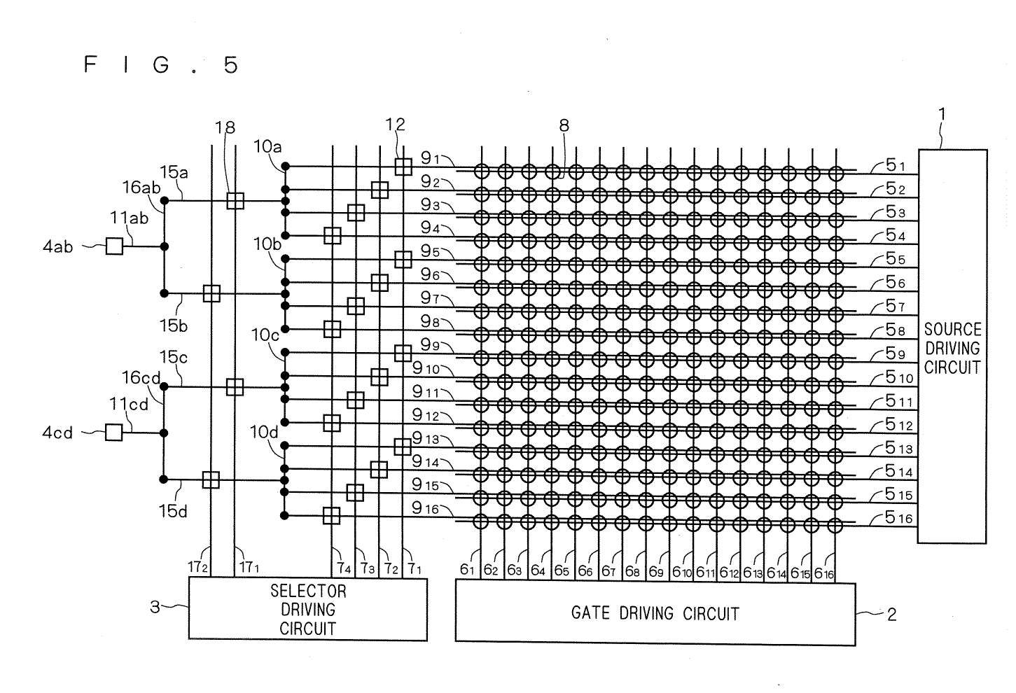

FIG. 5 is a view schematically showing a configuration of a liquid crystal display device with a built-in sensor array having a touch panel function according to the third embodiment of the present invention. Signal lines 10a, 10b, 10c, 10d are connected respectively to signal lines 15a, 15b, 15c, 15d. The signal lines 15a, 15b are connected to a signal line 16ab, and the signal lines 15c, 15d are connected to a signal line 16cd. The signal line 16ab is connected to an integrator 4ab through a signal line 11ab, and the signal line 16cd is connected to an integrator 4cd through a signal line 11cd.

Selector lines 17₁, 17₂, orthogonal to the signal lines 15a to 15d, are formed and connected to the selector driving circuit 3. An a-SiTFT 18 is formed at each of intersections of the selector line 17₁, and the signal lines 15a, 15c, and intersections of the selector line 17₂ and the signal lines 15b, 15d. For example, the a-SiTFT 18 formed at the intersection of the selector line 17₁ and the signal line 15a has a gate electrode connected to the selector line 17₁ and a source electrode and a drain electrode which are connected to the signal line 15a. The a-SiTFT 18 is turned on by driving of the selector line 17₁ by the selector driving circuit 3, to bring the signal line 15a into conduction.

Since two a-SiTFTs 18 are respectively connected to the selector lines 17₁, 17₂, the signal lines 15a, 15c are concurrently brought into conduction by driving of the selector line 17₁, and the signal lines 15b, 15d are concurrently brought into conduction by driving of the selector line 17₂. As in the case of the a-SiTFT 12, the a-SiTFT 18 can be formed in the same process as the a-SiTFT arranged at each of the intersections of the source lines 5₁ to 5₁₆ and the gate lines 6₁ to 6₁₆ within the display screen. Namely, a change in mask pattern allows formation of the a-SiTFTs 12, 18 outside the display screen concurrently with the formation of the a-SiTFT within the display screen in the array production process.

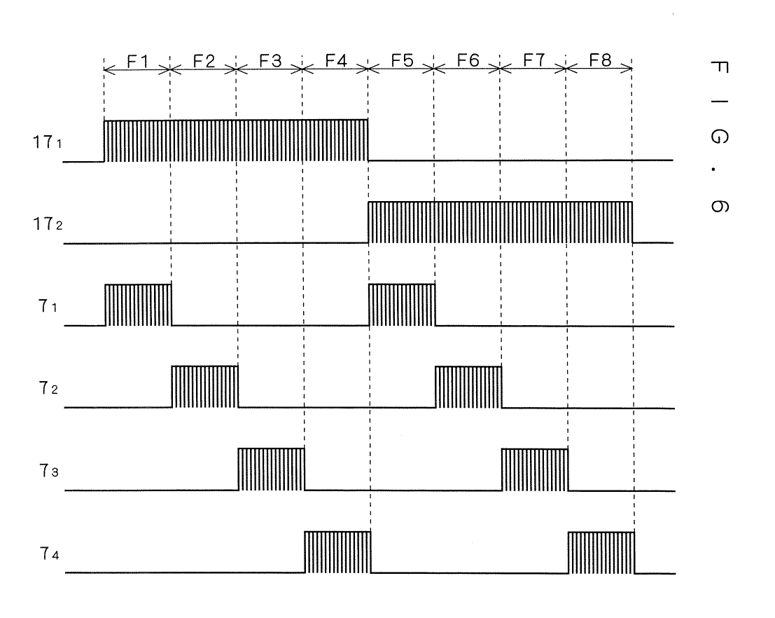

FIG. 6 is a timing chart showing the timing for driving the selector lines 7₁ to 7₄, 17₁, 17₂ by the selector driving circuit 3. The selector driving circuit 3 drives the selector line 17₁, during periods from the first frame F1 to the fourth frame F4, and the selector line 17₂ during periods from the fifth frame F5 to the eighth frame F8. Further, as in the case of the liquid crystal display device according to the first embodiment, the selector driving circuit 3 drives the selector lines 7₁ to 7₄ in sequence in the frame period. Specifically, the selector line 7₁ is driven in the first frame F1 and the fifth frame F5, the selector line 7₂ is driven in the second frame F2 and the sixth frame F6, the selector line 7₃ is driven in the third frame F3 and the seventh frame F7, and the selector line 7₄ is driven in the fourth frame F4 and the eighth frame F8. Thereby, for example in the first frame F1, signals detected in sequence in the gate period by the pixel sensors 8 connected to the signal lines 9₁, 9₉ are read with the integrators 4ab, 4cd, and in the fifth frame F5, signals detected in sequence in the gate period by the pixel sensors 8 connected to the signal lines 9₅, 9₁₃ are read with the integrators 4ab, 4cd. Then, during the eight frame period from the first frame F1 to the eighth frame F8, signals detected by all of the pixel sensors 8 within the display screen are read with the integrators 4ab, 4cd.

It is to be noted that, although the example is described above in which the selector driving circuit 3 drives the selector lines 7₁ to 7₄, 17₁, 17₂ in sequence in the frame period as in the case of the liquid crystal display device according to the first embodiment, the selector driving circuit 3 may drive the selector lines 7₁ to 7₄, 17₁, 17₂ in sequence in the gate period as in the case of the liquid crystal display device according to the second embodiment.

Further, although FIG. 5 shows a two-step selector configuration which includes the selector on the first step corresponding to the selector lines 7₁ to 7₄ and the selector on the second step corresponding to the selector lines 17₁, 17₂, a selector configuration including three steps or more can also be adopted.

As thus described, according to the liquid crystal display device with a built-in sensor array of the third embodiment, the signal lines 9₁ to 9₈ are brought together into one line by means of the signal lines 10a, 10b, 16ab, to be connected to the integrator 4ab. Further, the signal lines 9₉ to 9₁₆ are brought together into one line by means of the signal lines 10c, 10d, 16cd, to be connected to the integrator 4cd. Therefore, arrangement of the total two integrators 4ab and 4cd is sufficient with respect to the total sixteen signal lines 9₁ to 9₁₆. This can result in reduction in number of integrators, which permits an attempt to reduce cost, as compared to the configuration shown in FIG. 1.

Moreover, since the six selector lines 7₁ to 7₄, 17₁, 17₂ are sufficient in number, it is possible to reduce the number of selector lines from the configuration shown in FIG. 4, so as to reduce the area of the region to be secured for formation of the selector lines.

### Fourth Embodiment

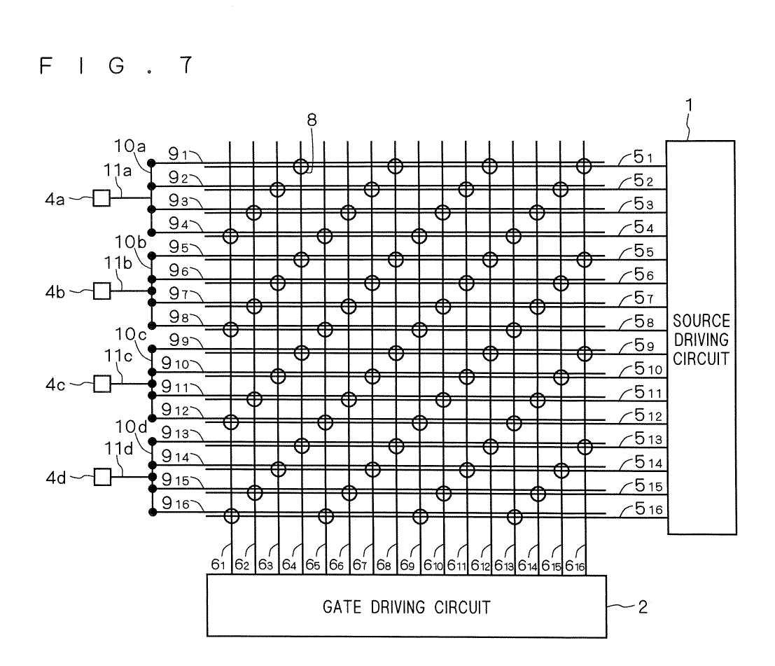

FIG. 7 is a view schematically showing a configuration of a liquid crystal display device with a built-in sensor array having a touch panel function according to the fourth embodiment of the present invention. The pixel sensor 8 is not arranged at each of intersections of the source lines 5₁ to 5₁₆ and the gate lines 6₁ to 6₁₆. Instead, within the range of matrix of total sixteen pixels which are arranged respectively at intersections of continuous four source lines and continuous four gate line, four pixel sensors 8 are arranged such that more than one pixel sensor 8 does not align on the same one source line and the same one gate line. Specifically, the pixel sensor 8 is arranged only at each of intersections of the source lines 5₁, 5₅, 5₉, 5₁₃ and the gate lines 6₄, 6₈, 6₁₂, 6₁₆, each of intersections of the source lines 5₂, 5₆, 5₁₀, 5₁₄ and the gate lines 6₃, 6₇, 6₁₁, 6₁₅, each of intersections of the source lines 5₃, 5₇, 5₁₁, 5₁₅ and the gate lines 6₂, 6₆, 6₁₀, 6₁₄, and each of intersections of the source lines 5₄, 5₈, 5₁₂, 5₁₆ and the gate lines 6₁, 6₅, 6₉, 6₁₃.

Further, in the liquid crystal display device with a built-in sensor array according to the fourth embodiment, the selector driving circuit 3, the selector lines 7₁ to 7₄ and the a-SiTFT 12 shown in FIG. 1 are not arranged.

Similarly to the above, the gate driving circuit 2 drives the gate lines 6₁ to 6₁₆ in sequence in a prescribed gate period. In the case where the gate line 6₁ is being driven, for example, respective signals detected with the pixel sensors 8 arranged at intersections of the source lines 5₄, 5₈, 5₁₂, 5₁₆ and the gate line 6₁ are read with the integrators 4a, 4b, 4c, 4d. Further, in the case where the gate line 6₂ is being driven, for example, respective signals detected with the pixel sensors 8 arranged at intersections of the source lines 5₃, 5₇, 5₁₁, 5₁₅ and the gate line 6₂ are read with the integrators 4a, 4b, 4c, 4d. Consequently, in the liquid crystal display device with a built-in sensor array according to the fourth embodiment, signals respectively detected with all the pixel sensors 8 within the display screen during one frame period are read with the integrators 4a to 4d.

According to the liquid crystal display device with a built-in sensor array of the fourth embodiment, by reduction in number of pixel sensors 8 to be arranged within the display screen, the number of integrators to be arranged with respect to the total sixteen signal lines 9₁ to 9₁₆ can be reduced to four, without the necessity to arrange the selector driving circuit 3 and the selector line 7₁ to 7₄ shown in FIG. 1. As a result, it is possible to attempt cost reduction as compared to the case of arranging the integrator on each signal line.

Moreover, since there is no need for arranging the selector driving circuit 3 and the selector lines 7₁ to 7₄ shown in FIG. 1, it is possible to attempt size reduction of the device as well as cost reduction.

### Fifth Embodiment

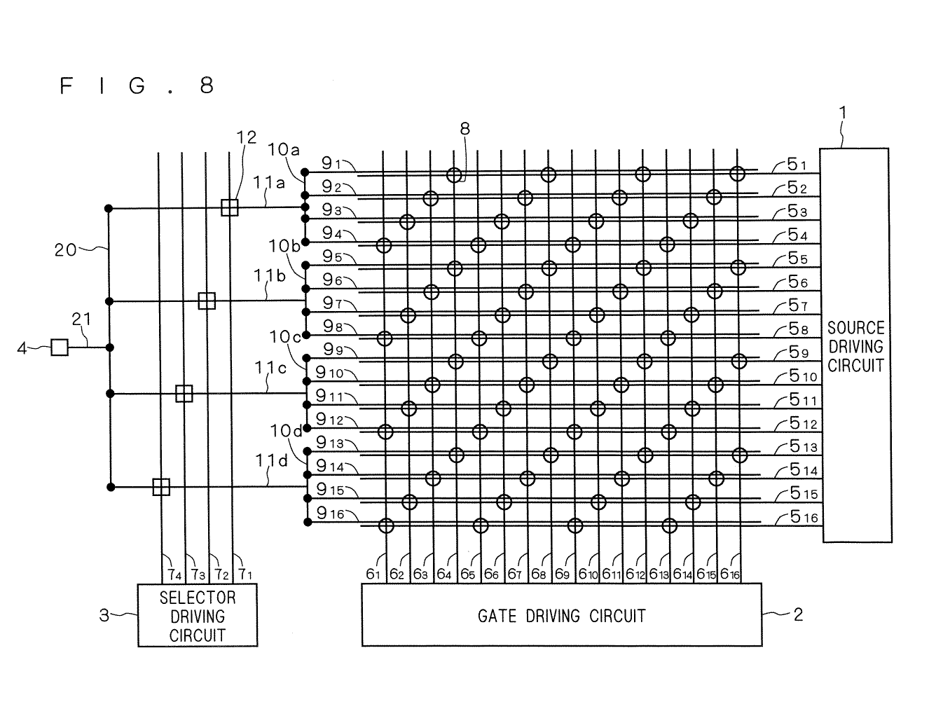

FIG. 8 is a view schematically showing a configuration of a liquid crystal display device with a built-in sensor array having a touch panel function according to the fifth embodiment of the present invention. Places of arrangement of the pixel sensors 8 are similar to those in the configuration shown in FIG. 7. Signal lines 10a to 10d are connected to signal lines 11a to 11d, and those signal lines 11a to 11d are connected to a signal line 20. The signal line 20 is connected to an integrator 4 through a signal line 21. Namely, the four signal lines 11a to 11d are brought together into one line by means of the signal line 20, to be connected to one integrator 4.

Four selector lines 7₁ to 7₄, orthogonal to the signal lines 11a to 11d, are formed and connected to the selector driving circuit 3. An a-SiTFT 12 is formed at each of an intersection of the selector line 7₁ and the signal line 11a, an intersection of the selector line 7₂ and the signal line 11b, an intersection of the selector line 7₃ and the signal line 11c, and an intersection of the selector line 7₄ and the signal line 11d. For example, the a-SiTFT 12 formed at the intersection of the selector line 7₁ and the signal line 11a has a gate electrode connected to the selector line 7₁ and a source electrode and a drain electrode which are connected to the signal line 11a. The a-SiTFT 12 is turned on by driving of the selector line 7₁ by the selector driving circuit 3, to bring the signal line 11a into conduction. In the same manner, the signal lines 11b, 11c, 11d are brought into conduction by driving of the selector lines 7₂, 7₃, 7₄, respectively.

The selector driving circuit 3 may drive the selector lines 7₁ to 7₄ in sequence in the frame period as in the case of the liquid crystal display device according to the first embodiment, or may drive the selector lines 7₁ to 7₄ in sequence in the gate period as in the case of the liquid crystal display device according to the second embodiment. For example in the case where the selector lines 7₁ to 7₄ are driven in the frame period, signals detected with total sixteen pixel sensors 8 connected to the signal lines 9₁ to 9₄ are read with the integrator 4 in the first frame F1, signals detected with total sixteen pixel sensors 8 connected to the signal lines 9₅ to 9₈ are read with the integrator 4 in the second frame F2, signals detected with total sixteen pixel sensors 8 connected to the signal lines 9₉ to 9₁₂ are read with the integrator 4 in the third frame F3, and signals detected with total sixteen pixel sensors 8 connected to the signal lines 9₁₃ to 9₁₆ are read with the integrator 4 in the fourth frame F4. Consequently, the signals respectively detected with all the pixel sensors 8 within the display screen are read with the integrator 4 during four frame periods from the first frame F1 to the fourth frame F4.

As thus described, according to the liquid crystal display device with a built-in sensor array of the fifth embodiment, the signal lines 9₁ to 9₁₆ are ultimately brought together into one signal line 21, to be connected to the integrator 4. Therefore, arrangement of only one integrator 4 is sufficient with respect to the total sixteen signal lines 9₁ to 9₁₆. This can result in reduction in number of integrators, which permits an attempt to reduce cost, as compared to the configuration shown in FIG. 1.

It is to be noted that, although the combinations of the liquid crystal display devices according to the first or second embodiment and the liquid crystal display device according to the fourth embodiment are described, it goes without saying that it is also possible to combine the liquid crystal display device according to the third embodiment with the liquid crystal display device according to the fourth embodiment.

### Sixth Embodiment

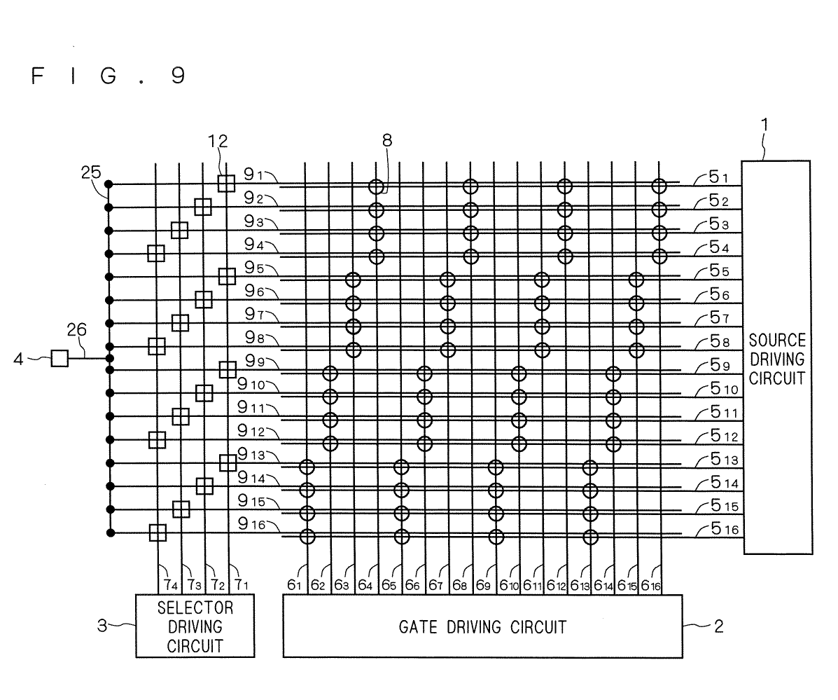

FIG. 9 is a view schematically showing a configuration of a liquid crystal display device with a built-in sensor array having a touch panel function according to the sixth embodiment of the present invention. The pixel sensor 8 is not arranged at each of intersections of the source lines 5₁ to 5₁₆ and the gate lines 6₁ to 6₁₆. Instead, four pixel sensors 8 are arranged with respect to each of the gate lines 6₁ to 6₁₆. Specifically, the pixel sensor 8 is arranged only at each of intersections of the source lines 5₁ to 5₄ and the gate lines 6₄, 6₈, 6₁₂, 6₁₆, each of intersections of the source lines 5₅ to 5₈ and the gate lines 6₃, 6₇, 6₁₁, 6₁₅, each of intersections of the source lines 5₉ to 5₁₂ and the gate lines 6₂, 6₆, 6₁₀, 6₁₄, and each of intersections of the source lines 5₁₃ to 5₁₆ and the gate lines 6₁, 6₅, 6₉, 6₁₃.

The signal lines 9₁ to 9₁₆ are connected to a signal line 25, and this signal line 25 is connected to an integrator 4 through a signal line 26. Namely, the sixteen signal lines 9₁ to 9₁₆ are brought together into one line by means of the signal line 25, to be connected to one integrator 4.

As in the configuration shown in FIG. 1, a plurality of selector lines 7₁ to 7₄, orthogonal to the signal lines 9₁ to 9₁₆, are formed and connected to the selector driving circuit 3. An a-SiTFT 12 is formed at each of intersections of the selector lines 7₁ and the signal lines 9₁, 9₅, 9₉, 9₁₃, intersections of the selector line 7₂ and the signal lines 9₂, 9₆, 9₁₀, 9₁₄, intersections of the selector line 7₃ and the signal lines 9₃, 9₇, 9₁₁, 9₁₅, and intersections of the selector line 7₄ and the signal lines 9₄, 9₈, 9₁₂, 9₁₆. The signal lines 9₁, 9₅, 9₉, 9₁₃ are brought into conduction by driving of the selector line 7₁. The signal lines 9₂, 9₆, 9₁₀, 9₁₄ are brought into conduction by driving of the selector line 7₂. The signal lines 9₃, 9₇, 9₁₁, 9₁₅ are brought into conduction by driving of the selector line 7₃. The signal lines 9₄, 9₈, 9₁₂, 9₁₆ are brought into conduction by driving of the selector line 7₄.

The selector driving circuit 3 may drive the selector lines 7₁ to 7₄ in sequence in the frame period as in the case of the liquid crystal display device according to the first embodiment, or may drive the selector lines 7₁ to 7₄ in sequence in the gate period as in the case of the liquid crystal display device according to the second embodiment. For example in the case where the selector lines 7₁ to 7₄ are driven in the frame period, signals detected with total sixteen pixel sensors 8 connected to the signal lines 9₁, 9₅, 9₉, 9₁₃ are read with the integrator 4 in the first frame F1, signals detected with total sixteen pixel sensors 8 connected to the signal lines 9₂, 9₆, 9₁₀, 9₁₄ are read with the integrator 4 in the second frame F2, signals detected with total sixteen pixel sensors 8 connected to the signal lines 9₃, 9₇, 9₁₁, 9₁₅ are read with the integrator 4 in the third frame F3, and signals detected with total sixteen pixel sensors 8 connected to the signal lines 9₄, 9₈, 9₁₂, 9₁₆ are read with the integrator 4 in the fourth frame F4. Consequently, the signals respectively detected with all the pixel sensors 8 within the display screen are read with the integrator 4 during four frame periods from the first frame F1 to the fourth frame F4.

As thus described, according to the liquid crystal display device with a built-in sensor array of the sixth embodiment, the signal lines 9₁ to 9₁₆ are ultimately brought together into one signal line 26, to be connected to the integrator 4. Therefore, arrangement of only one integrator 4 is sufficient with respect to the total sixteen signal lines 9₁ to 9₁₆. This can result in reduction in number of integrators, which permits an attempt to reduce cost, as compared to the configuration shown in FIG. 1.

Moreover, since there is no need for securing a region for forming the signal lines 10a to 10d, it is possible to attempt size reduction of the device as a whole, as compared to the configuration shown in FIG. 8.

Furthermore, in the configuration shown in FIG. 8, there is a limitation that, within the range of matrix of total sixteen pixels which are arranged respectively at intersections of continuous four source lines and continuous four gate line, four pixel sensors 8 are arranged such that more than one pixel sensor 8 does not align on the same one source line and the same one gate line. As opposed to this, in the liquid crystal display device according to the sixth embodiment, the four pixel sensors 8 can be arranged at arbitrary places with respect to the gate lines 6₁ to 6₁₆, whereby there are fewer restrictions than in the configuration shown in FIG. 8, and it is thus possible to expand variations in arrangement patterns of the pixel sensors 8.

It is to be noted that the liquid crystal display device according to the sixth embodiment can be combined with the liquid crystal display device according to the third embodiment.

### Seventh Embodiment

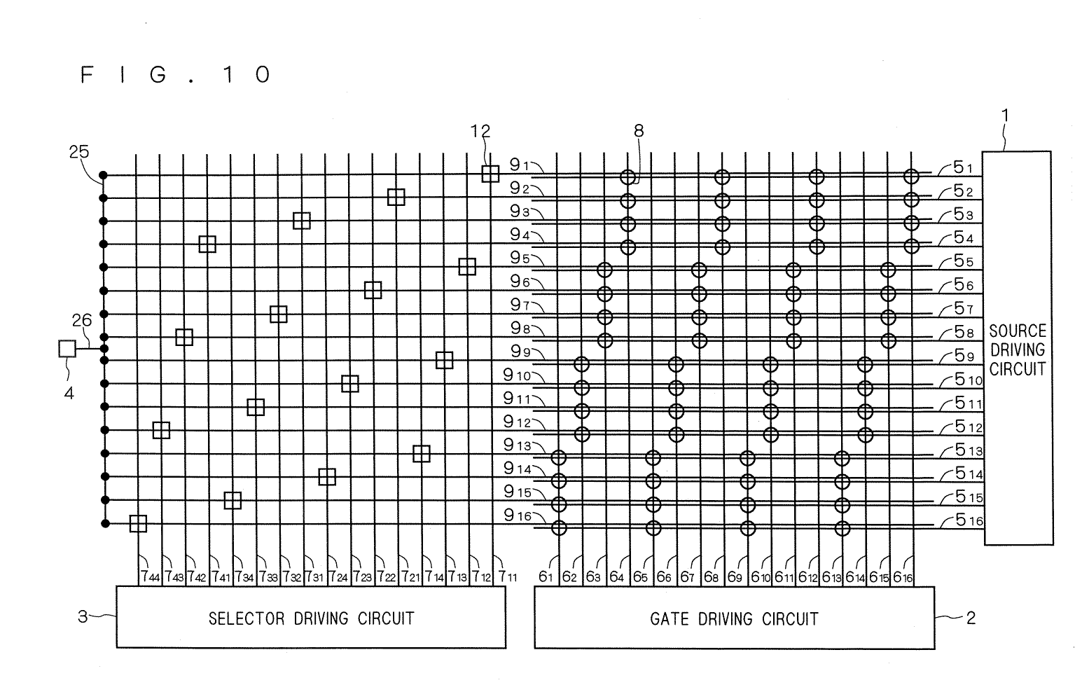

FIG. 10 is a view schematically showing a configuration of a liquid crystal display device with a built-in sensor array having a touch panel function according to the seventh embodiment of the present invention. Places of arrangement of the pixel sensors 8 are similar to those in the configuration shown in FIG. 9. Sixteen selector lines 7₁₁ to 7₁₄, 7₂₁ to 7₂₄, 7₃₁ to 7₃₄, 7₄₁ to 7₄₄, orthogonal to the signal lines 9₁ to 9₁₆, are formed and connected to the selector driving circuit 3. The selector lines 7₁₁, to 7₁₄, 7₂₁ to 7₂₄, 7₃₁ to 7₃₄, 7₄₁ to 7₄₄ are formed by dividing each one of the signal lines 7₁, 7₂, 7₃, 7₄ shown in FIG. 9 into four lines.

An a-SiTFT 12 is formed at each of an intersection of the selector line 7₁₁ and the signal line 9₁, an intersection of the selector line 7₁₂ and the signal line 9₅, an intersection of the selector line 7₁₃ and the signal line 9₉, an intersection of the selector line 7₁₄ and the signal line 9₁₃, an intersection of the selector line 7₂₁ and the signal line 9₂, an intersection of the selector line 7₂₂ and the signal line 9₆, an intersection of the selector line 7₂₃ and the signal line 9₁₀, an intersection of the selector line 7₂₄ and the signal line 9₁₄, an intersection of the selector line 7₃₁ and the signal line 9₃, an intersection of the selector line 7₃₂ and the signal line 9₇, an intersection of the selector line 7₃₃ and the signal line 9₁₁, an intersection of the selector line 7₃₄ and the signal line 9₁₅, an intersection of the selector line 7₄₁ and the signal line 9₄, an intersection of the selector line 7₄₂ and the signal line 9₈, an intersection of the selector line 7₄₃ and the signal line 9₁₂, and an intersection of the selector line 7₄₄ and the signal line 9₁₆. As thus described, only one a-SiTFT 12 is connected to each of the selector line 7₁₁ to 7₁₄, 7₂₁ to 7₂₄, 7₃₁ to 7₃₄, 7₄₁ to 7₄₄.

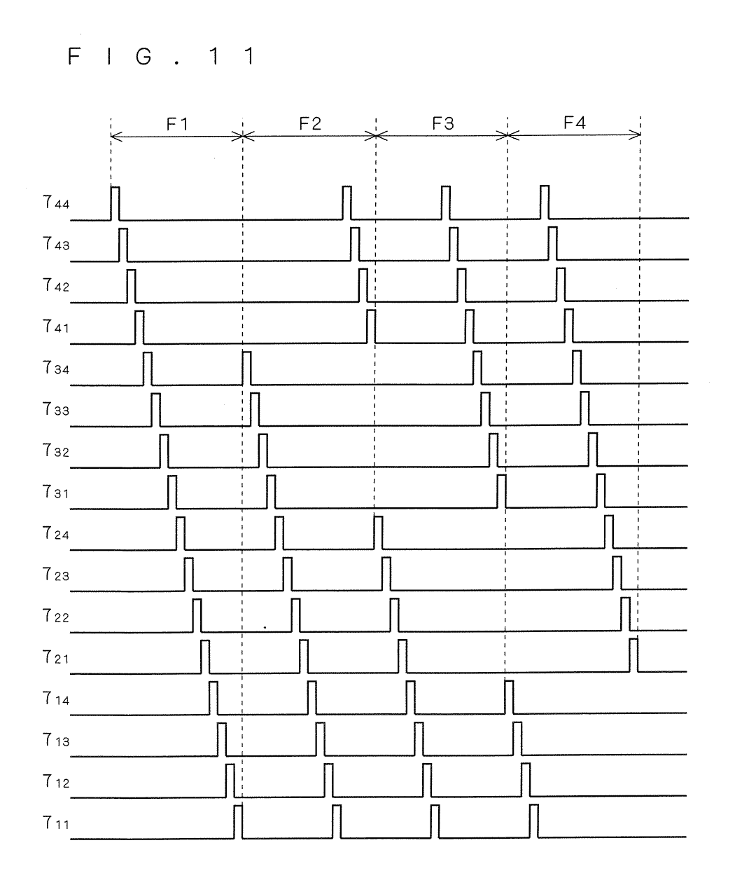

FIG. 11 is a timing chart showing the timing for driving the selector lines 7₁₁ to 7₁₄, 7₂₁ to 7₂₄, 7₃₁ to 7₃₄, 7₄₁ to 7₄₄ by the selector driving circuit 3. The gate driving circuit 2 drives the gate lines 6₁ to 6₁₆ in this order in the gate period during each frame period of the first frame F1 to the fourth frame F4. In synchronization with this, as shown in FIG. 11, the selector driving circuit 3 drives the selector lines 7₄₄, 7₄₃, 7₄₂, 7₄₁, 7₃₄, . . . 7₁₁ in this order in the gate period in the first frame F1, the selector driving circuit 3 drives the selector lines 7₃₄, 7₃₃, 7₃₂, 7₃₁, 7₂₄, . . . 7₄₁ in this order in the gate period in the second frame F2, the selector driving circuit 3 drives the selector lines 7₂₄, 7₂₃, 7₂₂, 7₂₁, 7₁₄, . . . 7₃₁ in this order in the gate period in the third frame F3, and the selector driving circuit 3 drives the selector lines 7₁₄, 7₁₃, 7₁₂, 7₁₁, 7₄₄, . . . 7₂₁ in this order in the gate period in the fourth frame F4. Thereby, signals respectively detected with all the pixel sensors 8 within the display screen are read with the integrator 4 during four frame periods from the first frame F1 to the fourth frame F4.

As thus described, according to the liquid crystal display device with a built-in sensor array of the seventh embodiment, the signal lines 9₁ to 9₁₆ are ultimately brought together into one signal line 26, to be connected to the integrator 4. Therefore, arrangement of only one integrator 4 is sufficient with respect to the total sixteen signal lines 9₁ to 9₁₆. This can result in reduction in number of integrators, which permits an attempt to reduce cost, as compared to the configuration shown in FIG. 1.

Moreover, only one a-SiTFT 12 is connected to one selector line in the liquid crystal display device with a built-in sensor array according to the seventh embodiment, whereas the four a-SiTFTs 12 are connected to one selector line in the configuration shown in FIG. 9. Since the number of signal lines 9₁ to 9₁₆ concurrently electrically connected to the integrator 4 is reduced to make a load capacity smaller, thereby allowing enhancement of the detection accuracy more than the configuration shown in FIG. 9.

It is to be noted that the liquid crystal display device according to the seventh embodiment can be combined with the liquid crystal display device according to the third embodiment.

### Eighth Embodiment

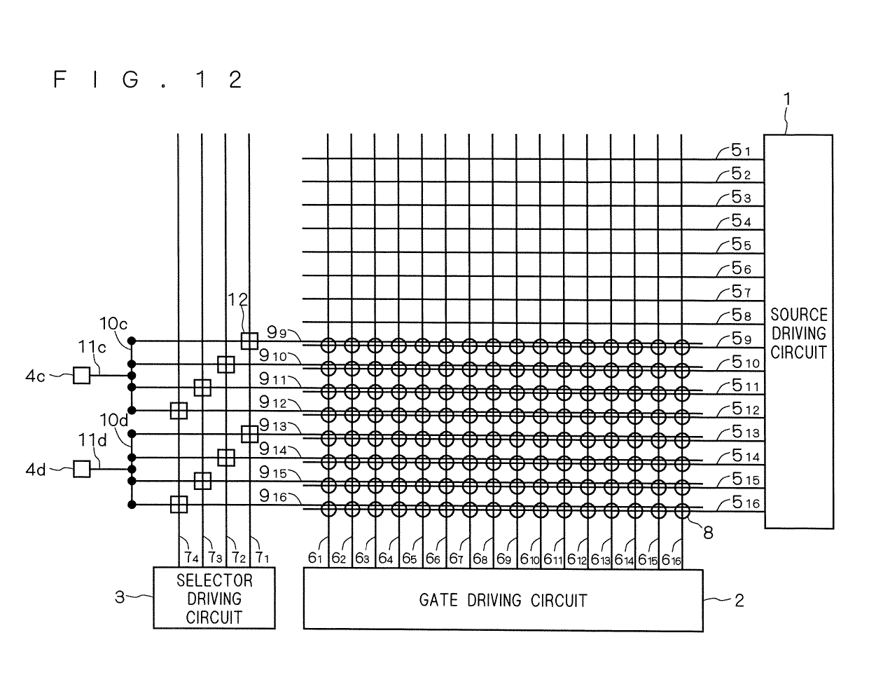

FIG. 12 is a view schematically showing a configuration of a liquid crystal display device with a built-in sensor array having a touch panel function according to the eighth embodiment of the present invention, based upon the liquid crystal display device according to the first embodiment shown in FIG. 1. The pixel sensors 8 are not arranged on the whole of the display screen, but arranged only in a region in part of the display screen. For example, when it is predetermined to display icons and menu items to be touched by an operator of the touch panel in the lower half part of the display screen, the pixel sensors 8 are arranged only in the region of the lower half of the display screen, as shown in FIG. 12. In the example shown in FIG. 12, the pixel sensors 8 are arranged within the pixels corresponding to the source lines 5₉ to 5₁₆ and the gate lines 6₁ to 6₁₆.

Since the pixel sensors 8 are not arranged in the region of the upper half of the display screen, it is possible to omit the arrangement of the signal lines 10a, 10b, 11a, 11b, the eight a-SiTFTs 12 corresponding to the signal lines 9₁ to 9₈, and the integrators 4a, 4b, which are shown in FIG. 1.

It should be noted that, although the example is described above in which the pixel sensors 8 are arranged only in the region of the lower half of the display screen, a region where the pixel sensors 8 are to be arranged is not limited to the lower half of the display screen, and may be an arbitrary region with respect to the column direction, such as the upper half or the central part of the display screen. Alternatively, the pixel sensors 8 may for example be arranged on every other line according to application.

Further, although the example is described above in which the invention according to the eighth embodiment is applied to the liquid crystal display device according to the first embodiment, the invention according to the eighth embodiment can also be applied to any of the liquid crystal display devices according to the second to seventh embodiments.

As thus described, according to the liquid crystal display device with a built-in sensor array according to the eighth embodiment, the pixel sensors 8 are not arranged on the whole of the display screen, but arranged only in a region in part of the display screen. It is therefore possible to omit arrangement of the integrator corresponding to the region where the pixel sensor 8 is not arranged, thereby allowing an attempt to reduce cost.

While the invention has been shown and described in detail, the foregoing description is in all aspects illustrative and not restrictive. It is therefore understood that numerous modifications and variations can be devised without departing from the scope of the invention.

What is claimed is:

1. A display device comprising:
first and second source lines formed within a display screen;
a gate line formed within said display screen and orthogonal to said first and second source lines;
a first pixel sensor arranged corresponding to an intersection of said first source line and said gate line;
a second pixel sensor arranged corresponding to an intersection of said second source line and said gate line;
a first signal line connected to said first pixel sensor;
a second signal line connected to said second pixel sensor;
an integrator; and
a selector for selectively connecting said first and second signal lines to said integrator.

2. The display device according to claim 1, wherein
a plurality of gate lines are arranged,
the plurality of gate lines are driven in sequence in a predetermined period to constitute one frame, and
said selector switches selection between said first and second signal lines in said predetermined period or in a frame period.

3. The display device according to claim 1, further comprising:
a first transistor having a gate electrode connected to said gate line, wherein said selector has a second transistor formed in the same process as said first transistor.

4. The display device according to claim 1, wherein
said pixel sensor is arranged only in a region in part of said display screen.

5. A display device comprising:
first to fourth source lines formed within a display screen;
a gate line formed within said display screen and orthogonal to said first to fourth source lines;
a first pixel sensor arranged corresponding to an intersection of said first source line and said gate line;
a second pixel sensor arranged corresponding to an intersection of said second source line and said gate line;
a third pixel sensor arranged corresponding to an intersection of said third source line and said gate line;
a fourth pixel sensor arranged corresponding to an intersection of said fourth source line and said gate line;
a first signal line connected to said first pixel sensor;
a second signal line connected to said second pixel sensor;
a third signal line connected to said third pixel sensor;
a fourth signal line connected to said fourth pixel sensor;
an integrator;
a first selector connected to said integrator;
a second selector for selectively connecting said first and second signal lines to said first selector; and
a third selector for selectively connecting said third and fourth signal line to said first selector, wherein
said first selector selectively connects said second and third selectors to said integrator.

6. The display device according to claim 5, wherein
a plurality of gate lines are arranged,
the plurality of gate lines are driven in sequence in a predetermined period to constitute one frame,
said second selector switches selection between said first and second signal lines in said predetermined period or in a frame period, and
said third selector switches selection between said third and fourth signal lines in said predetermined period or in a frame period.

7. The display device according to claim 5, further comprising:
a first transistor having a gate electrode connected to said gate line, wherein
each of said first to third selectors has a second transistor formed in the same process as said first transistor.

8. The display device according to claim 5, wherein
said pixel sensor is arranged only in a region in part of said display screen.

9. A display device comprising:
first to fourth source lines formed within a display screen;
first and second gate lines formed within said display screen, orthogonal to said first to fourth source lines, and driven in sequence;
a first pixel sensor arranged corresponding to an intersection of said first source line and said first gate line;
a second pixel sensor arranged corresponding to an intersection of said second source line and said second gate line;
a third pixel sensor arranged corresponding to an intersection of said third source line and said first gate line;
a fourth pixel sensor arranged corresponding to an intersection of said fourth source line and said second gate line;
a first signal line connected to said first pixel sensor;
a second signal line connected to said second pixel sensor;
a third signal line connected to said third pixel sensor;
a fourth signal line connected to said fourth pixel sensor;
a fifth signal line connected to said first and second signal line;
a sixth signal line connected to said third and fourth signal line;
an integrator; and
a selector for selectively connecting said fifth and sixth signal lines to said integrator.

10. The display device according to claim 9, wherein
a plurality of first gate lines and a plurality of second gate lines are arranged, respectively,
the plurality of first gate lines and the plurality of second gate lines are driven in sequence in a predetermined period to constitute one frame, and
said selector switches selection between said fifth and sixth signal lines in said predetermined period or in a frame period.

11. The display device according to claim 9, further comprising:
a first transistor having a gate electrode connected to said gate line, wherein
said selector has a second transistor formed in the same process as said first transistor.

12. The display device according to claim 9, wherein
said first to fourth pixel sensors are arranged only in a region in part of said display screen.

13. A display device comprising:
first to fourth source lines formed within a display screen;
first and second gate lines formed within said display screen, orthogonal to said first to fourth source lines, and driven in sequence;
a first pixel sensor arranged corresponding to an intersection of said first source line and said first gate line;
a second pixel sensor arranged corresponding to an intersection of said second source line and said first gate line;
a third pixel sensor arranged corresponding to an intersection of said third source line and said second gate line;
a fourth pixel sensor arranged corresponding to an intersection of said fourth source line and said second gate line;
a first signal line connected to said first pixel sensor;
a second signal line connected to said second pixel sensor;
a third signal line connected to said third pixel sensor;
a fourth signal line connected to said fourth pixel sensor;
an integrator; and
a selector for selectively connecting said first and second signal lines to said integrator, and selectively connecting said third and fourth signal lines to said integrator.

14. The display device according to claim 13, wherein
a plurality of first gate lines and a plurality of second gate lines are arranged, respectively,
the plurality of first gate lines and the plurality of second gate lines are driven in sequence in a predetermined period to constitute one frame,
said selector switches selection between said first and second signal lines in said predetermined period or in a frame period, and
said selector switches selection between said third and fourth signal lines in said predetermined period or in a frame period.

15. The display device according to claim 13, wherein
said selector includes:
first to fourth selector lines;
a first transistor driven by said first selector line and connected in between said first signal line and said integrator;
a second transistor driven by said second selector line and connected in between said second signal line and said integrator;
a third transistor driven by said third selector line and connected in between said third signal line and said integrator; and
a fourth transistor driven by said fourth selector line and connected in between said fourth signal line and said integrator.

16. The display device according to claim 13, further comprising:
a first transistor having a gate electrode connected to said gate line, wherein
said selector has a second transistor formed in the same process as said first transistor.

17. The display device according to claim 13, wherein
said first to fourth pixel sensors are arranged only in a region in part of said display screen.

18. A display device comprising:
first and second source lines formed within a display screen;
first and second gate lines formed within said display screen, orthogonal to said first and second source line, and driven in sequence;
a first pixel sensor arranged corresponding to an intersection of said first source line and said first gate line;
a second pixel sensor arranged corresponding to an intersection of said second source line and said second gate line;
a first signal line connected to said first pixel sensor;
a second signal line connected to said second pixel sensor; and
an integrator connected to said first and second signal lines.

19. The display device according to claim 18, wherein
said first and second pixel sensors are arranged only in a region in part of said display screen.
